(19) United States
(12) Patent Application Publication
(10) Pub. No.: US 2015/0213558 A1
(43) Pub. Date: Jul. 30, 2015

(54) SYSTEM AND METHODOLOGY FOR PREDICTIVE MODELING OF MITIGATION SCOPE AND COSTS OF STRUCTURAL WATER DAMAGE EVENTS

(71) Applicant: Loss Technology Services, LLC, Jacksonville, FL (US)

(72) Inventor: Edwin T. Nelson, Jacksonville, FL (US)

(73) Assignee: LOSS TECHNOLOGY SERVICES, LLC, Jacksonville, FL (US)

(21) Appl. No.: 14/604,007

(22) Filed: Jan. 23, 2015

Related U.S. Application Data
(60) Provisional application No. 61/931,014, filed on Jan. 24, 2014.

(51) Int. Cl. G06Q 40/08

(52) U.S. Cl. CPC G06Q 40/08

(57) ABSTRACT

A method of providing a reliable predictive model of the mitigation scope and costs of water damage events to structures is presented. The method takes into account FEMA guidelines, industry standards, local pricing variations, and data regarding damage to the particular structure.

This application claims the benefit of Untied States Provisional Patent Application Ser. No. 61/931,014, filed Jan. 24, 2014, the disclosure of which is incorporated by reference herein.

### BACKGROUND OF THE INVENTION

When structures suffer damage from prolonged exposure to water, such as may occur in floods, excessive storm water runoff, burst pipes or the like, the property owners will make claims against insurers for the costs of the repairs necessary to the structures. In many instances, structural cleaning and drying should be initiated as quickly as possible to mitigate the damages to the structure. Structural drying may include removal of standing water by suction pumps, removal of absorbed water by dehumidifiers, movement of air by blowers, etc. Mud and debris, damaged carpet, pads or other flooring, cabinets, drywall, etc., may need to be physically removed from the structure.

In a typical situation, an insurance adjustor will be brought to the structure to evaluate the damage and provide an estimate of the mitigation, repair and/or replacement costs. These adjustors will often lack the necessary experience and knowledge to properly predict the needs and costs of the mitigation, and therefore it is not uncommon for representatives of commercial mitigation companies to be brought in to provide the estimates. For example, an adjustor may have no idea as to what type of equipment or the numbers of particular equipment will be required, the duration of the mitigation work, the full extent of the damage, etc. As a self-interested party, the estimates from the commercial mitigation companies are subject to improper inflation.

It is an object of this invention to provide a system and methodology for the predictive modeling of the mitigation scope and costs that occur in a water damage event, primarily through the development and application of interactive and communicating computer systems utilizing software that incorporate a foundation of knowledge and experience in the field, plus guidelines put forth by FEMA and other agencies, that enables the accurate prediction of mitigation needs and costs in a reliable and repeatable manner through responses to directed inquiry sets. The system and methodology may be utilized by all industry participants to standardize and manage water damage event evaluation and response.

### BRIEF SUMMARY OF THE INVENTION

In general, the system and methodology is referred to herein as a Water Event Manager (WEM). The WEM may be used for example in predictive modeling for flood & P&C circumstances. By using the WEM system and methodology, the adjustor is able to quickly and easily provide an accurate estimate to the insurers of the proper needs and costs for the mitigation of the water damage to the structure. The estimate takes into account FEMA guidelines, industry standards, local pricing variations, and data regarding damage to the particular structure.

### BRIEF DESCRIPTION OF THE DRAWINGS

FIG. 1 is a diagram model of a prior art system and methodology.

FIG. 2 is a diagram model of the WEM system and methodology.

FIG. 3 is a flow chart diagram of the WEM system and methodology.

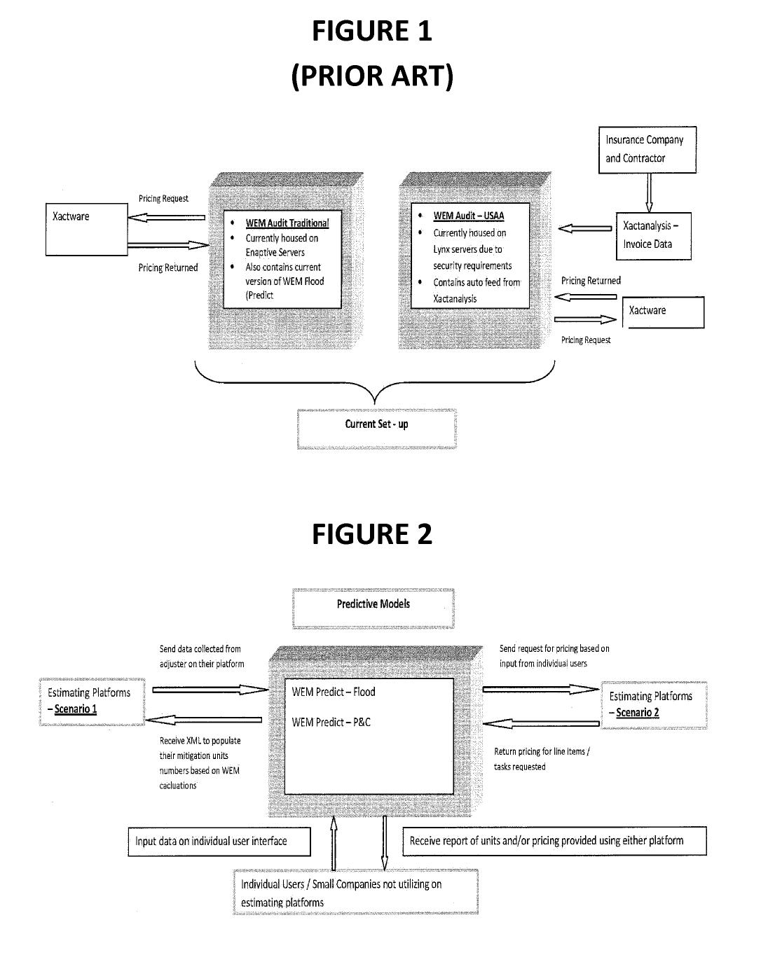

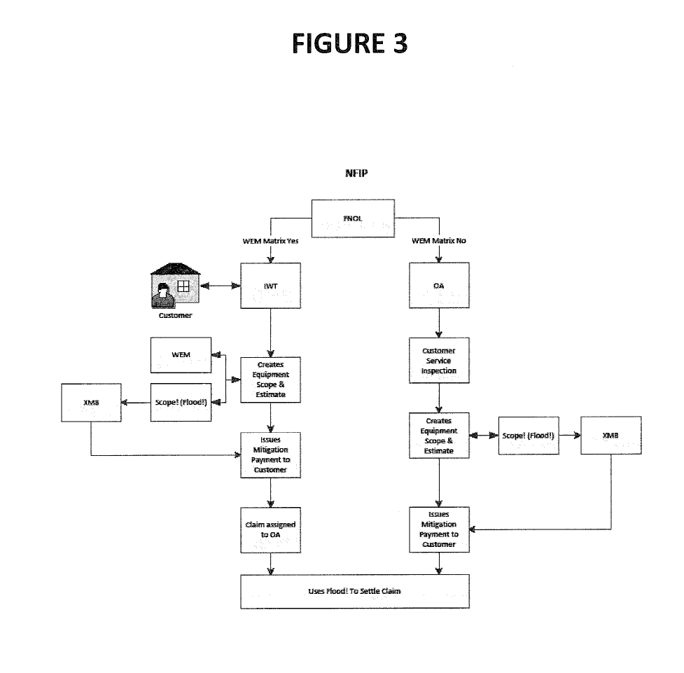

### DETAILED DESCRIPTION OF THE INVENTION

The WEM Predictive—Flood Version methodology for use in flood or water damage instances to structures is now to be described.

The WEM Flood Predict (WEMfp) provides for the modeling of predicted water mitigation scope of work and costs based on (1) Industry Guidelines, (2) data gathered through mitigation file auditing from 2003-2013, (3) FEMA guidelines provided in May of 2013 and (4) scripted questioning of the policyholder and/or representative. The scripted questioning is designed to ascertain the minimum information needed in order to run specific calculations/algorithims using the required data to model the drying/mitigation project. Also utilized within the calculation and output are the specific criteria set forth in FEMA guidance w-13025.

The user will utilize the system either from being on the phone with the policyholder to answer the specific required questions (data collection) or use the same process while on-site at the loss address. If on location, the data could be information obtained from the policyholder or by data collection by the adjuster.

Once all questions are answered the system utilizes the data to develop the scope of the project. The quantity of time (days), labor, equipment, materials is then ascertained. (1) When requesting Xactware pricing model the quantity and line items are transmitted to Xactware via XML data transfer, the line items are then returned with specific pricing for the zip code and time period (pricing is changed monthly). (2) When requesting SIMSOL pricing the model marries the line items with the costing data base which resides within the system and is updated semi-annually.

The report produced is then used to provide the policyholder with an expected payment amount that will be provided to conduct the mitigation portion of the loss. It is expected that the contractor would be provided a copy of the report by the homeowner and/or adjuster so that the contractor will also be aware of the expected payment. The contractor can then decide whether the job payment is adequate based on their evaluation of the loss.

The additional use planned is within the contractor network area of the industry. The previous procedures would be utilized but the estimate would be provided to a contractor network that has previously commitment to accepting the project scopes produced by the program. Used in this manner the output is used “almost” like a project blueprint.

The overall strategy of the predictive modeling software is to get ahead of a problem that has been plaguing the insurance industry in which they are billed 2-3 times the amount at which a project should cost . . . and are left to negotiate down from a high bill. The Predictive procedure and process arms the policyholder, adjuster and insurance company with a estimate prior to mitigation work being conducted and essentially working from a more accurate point in the negotiation process and prior to commitment being made to the contractor to “pay any and all fees” without verification of necessity.

Thus, the invention is a method of providing a reliable predictive model of the mitigation scope and costs of water damage events to structures comprising the steps of maintaining a database of industry guidelines relative to water damage mitigation; maintaining a database of historical mitigation data gathered through mitigation file auditing; maintaining a database of FEMA guidelines directed to water damage mitigation; maintaining a scripted questionnaire directed to ascertaining data from a specific water damage to structure event; providing a computer system operating an analytical program to analyze said database of industry guidelines, said database of historical mitigation, said database of FEMA guidelines, and said data ascertained from said scripted questionnaire; in response to a water damage to structure event, obtaining data ascertained from said scripted questionnaire and providing said data ascertained from said scripted questionnaire to said analytical program on said computer system; and analyzing said database of industry guidelines, said database of historical mitigation, said database of FEMA guidelines, and said data ascertained from said scripted questionnaire and producing an estimate of the mitigation scope and costs for said water damage to structure event. Furthermore, the step of producing an estimate of the mitigation scope and costs for said water damage to structure event comprising producing information on equipment required for mitigation, time required for mitigation, tasks required for mitigation, and supplies required for mitigation. The method may further comprise the step of providing said estimate of the mitigation scope and costs for said water damage to structure event to a policyholder or an insurance provider for the structure incurring said water damage to structure event. The method may further comprise the step of ascertaining bids from contractors after said step of analyzing said database of industry guidelines, said database of historical mitigation, said database of FEMA guidelines, and said data ascertained from said scripted questionnaire and prior to said step of producing an estimate of the mitigation scope and costs for said water damage to structure event.

Table I is an example of the scripted questions and representative answers required to ascertain data relative to the extent of flood or water damage to the structure for input into the analytical system.

TABLE I
WEM Predict Questions

| | | |
|---|---|---|
| 1 | From the start of drying, what is the lapsed number of days since demolition, cleaning & | 1 |
| | sanitizing was completed? | |
| 2 | How long (days) did flood water remain? | 4 |
| 3 | Was there a basement flooded? (A true basement has no exits/entrance on grade) | Yes |
| 4 | Were there floors above grade affected by flood waters? | Yes |
| 5 | Was there a crawlspace flooded? | Yes |

On Grade Structure Questions

| | | |
|---|---|---|
| S1 | What is the total size (in square feet) of the damaged area for floors above grade? | 2000 |
| S2 | How many floors above grade were affected? | 1 |
| S3 | What is the average ceiling height (in feet) of the above grade damaged area? | 8 |
| S4 | What was depth (in feet) of flood water in the above grade damage area? | 2.0 |
| S5 | How many rooms above grade were affected, excluding closets? | 10 |
| S6 | How many bedrooms were affected? | 4 |
| S7 | What was the height (in inches) of exterior wall covering (i.e. drywall) removed during | 48.0 |
| | demolition? If none removed enter 0. | |
| S8 | What was the height (in inches) of interior wall covering (i.e. drywall) removed during | 48 |
| | demolition? If none removed enter 0. | |
| S9 | Was the exterior wall sheathing replaced? | Yes |
| S10 | What percentage of the above grade flooring was salvageable? | 0% |
| S11 | Will above grade floor cleaning require mud removal, if so, select the approximate depth? | <1 inch |

Basement Questions

| | | |
|---|---|---|
| B1 | What is the total size (in square feet) of the damaged area in the basement | 1000 |
| B2 | What is the average ceiling height (in feet) within the affected basement area? | 8 |
| B3 | How many rooms were damaged. | 4 |
| B4 | What was the depth, (in feet) of flood water in the basement area? | 8 |
| B5 | Were 1st floor joists affected? | Yes |
| B6 | Was pump out of flood water in the basement required? | Yes |
| B8 | Is the basement finished? (wood studded walls with coverings) | Yes |
| B9 | If basement was finished, was the wall covering (i.e. drywall) removed during demolition? | Yes |
| | If none removed enter 0. | |
| B10 | If basement was finished, were the wall studs (including exterior) removed from the | Yes |
| | basement area? | |
| B11 | Did floor cleaning require mud removal, if so, what was the depth of the mud? | 3 to 6 |
| | | inches |

Crawlspace Questions

| | | |
|---|---|---|
| C1 | What is the total size (in square feet) of the damaged area in the crawlspace | 1000 |
| C2 | What is the average height (in feet) within the affected crawlspace area? | 4 |
| C3 | What was the depth, (in feet) of flood water in the crawl space area? | 4 |
| C4 | Were 1st floor joists affected? | Yes |
| C6 | How many separate areas in the crawlspace were affected? | 3 |
| C7 | How many exterior vents from the crawlspace, if unknown enter zero (0) | 8 |

Example I below is a representative example of a mitigation estimate report produced by the WEM system and methodology.

### Example I

Thank you for utilizing WEM Predict Flood. We appreciate the opportunity to provide you with the most effective and accurate mitigation and restoration predictive analytics available in the industry.

The estimate presented includes several drying related equipment requirements (duration, size and amount) that are included based on the information provided and then applied against industry standards and guidelines. The projected amounts provide for the necessary equipment and duration to properly dry the structure based on IICRC guidelines and industry standards. The equipment recommendation is calculated based on the amount of water damaged area, source of the water, amount of time water remained within the structure prior to extraction, size of the structure, the elapsed time between demolition and the beginning of drying and the required moisture removal necessary to meet the drying standard.

This evaluation does not take into consideration specific equipment availability of the vendor, only the most effective deployment of appropriate equipment that should be utilized on the loss. Likewise, it assumes that the drying vendor has all equipment operating according to the manufacture specifications.

The equipment evaluated includes:
a. Dehumidifiers—Number of units, size (in AHAM rating in pints) and duration in days
b. Air Mover—Number of units and duration in days
c. Generators—Number of days and size required to run recommended equipment, if beyond the capacity of the home/structure.

Likewise, there are several task and labor components which are evaluated based on the information requested. These items include:
a. Water Extraction
b. Equipment set up and take down
c. Daily monitoring
d. Heavy floor cleaning when required for drying purposes (i.e. mud and/or heavy silt)
e. Contents manipulation or removal from the premises (move and reset)

Normal and expected supplies are considered included in the cost of the rental fees, unit costs and labor rates.

If items are not specifically listed within the report or discussed above, the item/task should be considered not included in this evaluation.

Specific items that are not evaluated within the scope of this report include:
a. Carpet and pad removal
b. Other flooring (tile, wood, etc.) removal
c. Cabinet/Vanity removal
d. Drywall removal

### Notice to Mitigation Contractors

The following information regarding the general drying process is provided based on the payment guidelines as established by FEMA Guidance 13025a. To ensure payment of the mitigation/drying process these criteria should be considered prior to the start of the project.
1. All demolition of required materials within the structure should be conducted prior to the start of drying.
2. Removal of all non-salvageable items (carpet, clothing, furnishings, etc) should be removed prior to the start of the drying project.
3. Electricity should be restored to the structure. Generators are not covered item unless used to supplement the power required for specific equipment such as desiccant dryers (when required).
4. Dehumidifiers should not be consider for areas of a building exposed to soil or outdoor conditions, e.g., crawlspaces, attached garages, or attached utility and storage rooms.
5. Air movers placed within crawlspaces should be utilized to mechanically direct air movement throughout the area. Therefore, payment for air movers is limited to ½ the number of open vents within the crawlspace.
6. Detailed and accurate drying logs should be prepared and available for review. At a minimum, drying log data should contain daily readings of moisture content, location of affected and non-affected substrates, temperature, humidity, and drying goals/standards. Any drying plan beyond a duration of 3 days will require drying log review.

### Policyholder Information

The following information is provided as a “tip sheet” to assist the homeowner in reducing the level of secondary damage caused by absent, delayed or improper mitigation.
1. Remove all standing water.
2. Remove any silt or mud deposited in the home during the flood event.
3. Water damaged materials and furnishings should be removed from the home as soon as possible.
4. Water damaged drywall should be documented and removed.
5. Remove all water damaged carpeting.
6. The homes HVAC system should be repaired and returned to operation prior to conducting the drying process.
7. Once operational, the HVAC system should be set for continuous fan operation to increase air flow within the home.
8. Turn on all ceiling fans within the home that are in areas affected by water damage
9. Provide this report and information to your water/drying mitigation contractor (if employed)
10. Contact your adjuster with any questions

### Report

Date of Loss Dec. 1, 2013
Loss Address Zip Code 32225
From the start of drying, what is the lapsed number of days since demolition, cleaning & sanitizing was completed? 1
How long (days) did flood water remain? 9
Was there a basement flooded? (A true basement has no exits/entrance on grade) Yes
Were there floors above grade affected by flood waters? Yes
Was there a crawlspace flooded? Yes

### On Grade Structure Questions

What is the total size (in square feet) of the damaged area for floors above grade? 2,000
How many floors above grade were affected? 1
What is the average ceiling height (in feet) of the above grade damaged area? 8
What was depth (in feet) of flood water in the above grade damage area? 2
How many rooms above grade were affected, excluding closets? 5
How many bedrooms were affected? 3
What was the height (in inches) of exterior wall covering (i.e. drywall) removed during demolition? If none removed enter 0.48
What was the height (in inches) of interior wall covering (i.e. drywall) removed during demolition? If none removed enter 0.48

Was the exterior wall sheathing replaced? Yes
What percentage of the above grade flooring was salvageable? 0%
Will above grade floor cleaning require mud removal, if so, select the approximate depth? >6 inches

### Continue with Basement Questions

What is the total size (in square feet) of the damaged area in the basement? 1,000
What is the average ceiling height (in feet) within the affected basement area? 8
How many rooms were damaged? 4
What was the depth, (in feet) of flood water in the basement area? 8
Were 1st floor joists affected? Yes
Was pump out of flood water in the basement required? Yes
Is the basement finished? (wood studded walls with coverings) Yes
If basement was finished, was the wall covering (i.e. drywall) removed during demolition? If none removed enter 0. Yes
If basement was finished, were the wall studs (including exterior) removed from the basement area? Yes
Did floor cleaning require mud removal, if so, what was the depth of the mud? 3 to 6 inches

### Continue with Crawlspace Questions

What is the total size (in square feet) of the damaged area in the crawlspace? 500
What is the average height (in feet) within the affected crawlspace area? 4
What was the depth, (in feet) of flood water in the crawl space area? 4
Were 1st floor joists affected? Yes
How many separate areas in the crawlspace were affected? 1
How many exterior vents from the crawlspace? if unknown enter 0.6

### Structure Above Grade

### 3-Day Project, Class 2 Water Damage and Scenario D Drying Conditions

### Categories—Units—Daily Recommended Quantity—Total Project Resource—Estimated Cost

Dehumidification—320 pints per day—1 Large Unit(s) & 2 Xlarge Unit(s)—3 Large Unit(s) & 6 Xlarge Unit(s)—$945
Air Movers—Estimated 369 sf per air mover unit—6 Units Day 1, 3 Units
Day 2 &2 Units Day 3—11 Total Rental Days—$294
Equipment Setup & Takedown—Hours—9 Units—3 hours—$134
Equipment Monitoring—Hours—2 Monitoring Visit—4 hours—$179
Water Extraction—SF—2,000 SF—8.7 hours—$442
Antimicrobial Application—SF—2,000 SF—7 hours—$374
Content Manipulation—Room—5 Rooms—4 hours—$170
Mud Removal—SF—2,000 SF—27.1 hours—$948
Total Cost $3,486

### Basement

### 3-Day Project, Class 3 Water Damage and Scenario C Drying Conditions

### Categories—Units—Daily Recommended Quantity—Total Project Resource—Estimated Cost

Dehumidification—200 pints per day—1 Large Unit(s) & 1 Xlarge Unit(s)—3 Large Unit(s) & 3 Xlarge Unit(s)—$590
Air Movers—Estimated 107 sf per air mover unit—10 Units Day 1, 5 Units Day 2 & 3 Units Day 3—18 Total Rental Days—$482
Equipment Setup & Takedown—Hours—12 Units—3.5 hours—$156
Equipment Monitoring—Hours—2 Monitoring Visit—4 hours—$179
Water Extraction—SF—1,000 SF—4.4 hours—$221
Antimicrobial Application—SF 1,000 SF—3.5 hours—$187
Mud Removal—SF—1,000 SF—8.8 hours—$311
Clean Walls and Floor—SF of Floor & Affected Walls—2,012 SF—20.6 hours—$596
Pumpout—3000 GPH—59,840 GAL—19.9 hours—$1,015
Total Cost $3,737

### Crawlspace

### 3-Day Project

### Categories—Units—Quantity—Resource—Estimated Cost

Air Movers—167 sf per air mover unit—3 Units per Day—9 Total Rental Days—$241
Equipment Setup & Takedown—Hours—3 Units—0.8 hours—$34
Equipment Monitoring—Hours—2 Monitoring Visit—4 hours—$179
Antimicrobial Application—SF—500 SF—1.7 hours—$94
Total Cost $547

### Summary of Structure on Grade, Basement and Crawlspace

### Categories—Units—Daily Recommended Quantity—Total Project Resource—Estimated Cost

Dehumidification—520 pints per day—2 Large Unit(s) & 3 Xlarge Unit(s)—6 Large Unit(s) & 9 Xlarge Unit(s)—$1,535
Air Movers—Estimated 107 to 369 sf per air mover unit—19 Units Day 1, 11 Units Day 2 & 8 Units Day 3—38 Total Rental Days—$1,017
Equipment Setup & Takedown—Hours—24 Units—7.3 hours—$324
Equipment Monitoring—Hours—2 Monitoring Visit(s)—4 hours—$179
Water Extraction—SF—3,000 SF—13.1 hours—$663
Antimicrobial Application—SF—3,500 SF—12.2 hours—$655
Content Manipulation—per Room (on grade only)—5 Rooms—4 hours—$170
Mud Removal—SF—3,000 SF—35.9 hours—$1,259
Clean Walls and Floor—SF (basement)—2,012 SF—20.6 hours—$596
Pumpout—GPM (basement only)—59,840 GAL—19.9 hours at 100 gpm—$1,015
Total Cost $7,412

### Unit Costs Used for the Prediction of Xactimate and a Zip Code of 32225

### Task/Equipment—Units—Cost

Large Dehumidifier (65-109 pts)—Daily—$78.31
Extra Large Dehumidifiers (110-149 pts)—Daily—$118.37
Centrifugal Airmovers—Daily—$25.57
Axial Airmover—Daily—$27.95
Labor Rate—Hours—$44.68
Content Manipulation—Room—$34.02
Extraction—Square feet—$0.22
Antimicrobial—Square feet—$0.19
Mud Removal Light—Square feet—$0.16
Mud Removal Medium—Square feet—$0.23
Mud Removal Heavy—Square feet—$0.31
Mud Removal Very Heavy—Square feet—$0.47
Clean Walls—Square feet—$0.24
Clean Floors—Square feet—$0.36
Pump out (equipment & labor)—Hours—$50.90

### Estimated Daily Costs for the Structure on Grade

### Daily Air Mover Use Based on Recommended First Day Quantity

### Task—First Day—Days Between First and Last Day—Last Day

Dehumidification—$315—$315—$315
Air Movers—$161—$161—$161
Equipment Setup & Takedown—$67—$0—$67
Equipment Monitoring—$0—$89—$0
Water Extraction—$442—$0—$0
Antimicrobial Application—$374—$0—$0
Content Manipulation $170—$0—$0
Mud Removal $948—$0—$0
Total Cost—$2,477—$565—$543

### Estimated Daily Costs for the Basement

### Daily Air Mover Use Based on Recommended First Day Quantity

### Task—First Day—Days Between First and Last Day—Last Day

Dehumidification—$197—$197—$197
Air Movers—$268—$268—$268
Equipment Setup & Takedown—$78—$0—$78
Equipment Monitoring—$0—$89—$0
Water Extraction—$221—$0—$0
Antimicrobial Application—$187—$0—$0
Mud Removal—$311—$0—$0
Clean Walls and Floor—$596—$0—$0
Pumpout—$1,015—$0—$0
Total Cost—$2,873—$554—$542

### Estimated Daily Costs for the Crawlspace

### Daily Air Mover Use Based on Recommended First Day Quantity

### Task—First Day—Days Between First and Last Day—Last Day

Air Movers—$80—$80—$80
Equipment Setup & Takedown—$17—$0—$17
Equipment Monitoring—$0—$89—$0
Antimicrobial Application—$94—$0—$0
Total Cost—$191—$170—$97

### Estimated Daily Costs for the Combined Structure on Grade, Basement and Crawlspace

### Daily Air Mover Use Based on Recommended First Day Quantity

### Task—First Day—Days Between First and Last Day—Last Day

Dehumidification—$512—$512—$512
Air Movers—$508—$508—$508
Equipment Setup & Takedown—$162—$0—$162
Equipment Monitoring—$0—$89—$0
Water Extraction—$663—$0—$0
Antimicrobial Application—$655—$0—$0
Content Manipulation—$170—$0—$0
Mud Removal—$1,259—$0—$0
Clean Walls and Floor—$596—$0—$0
Pumpout—$1,015—$0—$0
Total Cost—$5,540—$1,110—$1,182

It is understood that equivalents and substitutions for certain elements set forth above may be obvious to those of skill in the art, and therefore the true scope and definition of the invention is to be as set forth in the following claims.

I claim:

1. A method of providing a reliable predictive model of the mitigation scope and costs of water damage events to structures comprising the steps of:
A. maintaining a database of industry guidelines relative to water damage mitigation;
B. maintaining a database of historical mitigation data gathered through mitigation file auditing;
C. maintaining a database of FEMA guidelines directed to water damage mitigation;
D. maintaining a scripted questionnaire directed to ascertaining data from a specific water damage to structure event;
E. providing a computer system operating an analytical program to analyze said database of industry guidelines, said database of historical mitigation, said database of FEMA guidelines, and said data ascertained from said scripted questionnaire;
F. in response to a water damage to structure event, obtaining data ascertained from said scripted questionnaire and providing said data ascertained from said scripted questionnaire to said analytical program on said computer system;
G. analyzing said database of industry guidelines, said database of historical mitigation, said database of FEMA guidelines, and said data ascertained from said scripted questionnaire and producing an estimate of the mitigation scope and costs for said water damage to structure event.

2. The method of claim 1, said step of producing an estimate of the mitigation scope and costs for said water damage to structure event comprising producing information on equipment required for mitigation, time required for mitigation, tasks required for mitigation, and supplies required for mitigation.

3. The method of claim 1, further comprising the step of providing said estimate of the mitigation scope and costs for said water damage to structure event to a policyholder for the structure incurring said water damage to structure event.

4. The method of claim 1, further comprising the step of providing said estimate of the mitigation scope and costs for said water damage to structure event to an insurance provider holding a policy covering the structure incurring said water damage to structure event.

5. The method of claim 3, further comprising the step of providing said estimate of the mitigation scope and costs for said water damage to structure event to an insurance provider holding a policy covering the structure incurring said water damage to structure event.

6. The method of claim 1, further comprising the step of ascertaining bids from contractors after said step of analyzing said database of industry guidelines, said database of historical mitigation, said database of FEMA guidelines, and said data ascertained from said scripted questionnaire and prior to said step of producing an estimate of the mitigation scope and costs for said water damage to structure event.

7. The method of claim 6, said step of producing an estimate of the mitigation scope and costs for said water damage to structure event comprising producing information on equipment required for mitigation, time required for mitigation, tasks required for mitigation, and supplies required for mitigation.

8. The method of claim 6, further comprising the step of providing said estimate of the mitigation scope and costs for said water damage to structure event to a policyholder for the structure incurring said water damage to structure event.

9. The method of claim 6, further comprising the step of providing said estimate of the mitigation scope and costs for said water damage to structure event to an insurance provider holding a policy covering the structure incurring said water damage to structure event.

10. The method of claim 9, further comprising the step of providing said estimate of the mitigation scope and costs for said water damage to structure event to an insurance provider holding a policy covering the structure incurring said water damage to structure event.
